(19) United States
(12) Patent Application Publication
(10) Pub. No.: US 2025/0330057 A1
(43) Pub. Date: Oct. 23, 2025

(54) MAGNETIC COUPLINGS

(71) Applicant: FluxWorks, INC., Conroe, TX (US)

(72) Inventors: Matthew Johnson, College Station, TX (US); Bryton Praslicka, Houston, TX (US)

(21) Appl. No.: 19/258,398

(22) Filed: Jul. 2, 2025

Related U.S. Application Data
(63) Continuation of application No. PCT/US2024/010212, filed on Jan. 3, 2024.
(60) Provisional application No. 63/478,461, filed on Jan. 4, 2023.

(51) Int. Cl. H02K 7/00; H02K 16/02

(52) U.S. Cl. CPC H02K 7/003; H02K 16/02

(57) ABSTRACT

A mechanical device may include a first rotor comprising a first magnetic material including a first plurality of pole pairs disposed about a rotational axis. A mechanical device may include a second rotor comprising a second magnetic material different from the first magnetic material, the second magnetic material including a second plurality of pole pairs disposed about the rotational axis, the first and second plurality of pole pairs magnetically coupled together such that rotation of the first rotor about the rotational axis imparts rotation of the second rotor about the rotational axis.

### CROSS-REFERENCE TO RELATED APPLICATIONS

This application is a continuation of International Application No. PCT/US2024/010212, filed Jan. 3, 2024, which claims priority to U.S. Provisional Patent Application No. 63/478,461, filed Jan. 4, 2023, the entire contents of each of which are hereby incorporated by reference in their entirety and for all purposes.

### BACKGROUND

### Field

The field relates to magnetic couplings.

### Description of the Related Art

Rotating mechanical components, such as motor shafts, interact with other components of a larger device or system to impart motion to the other components, or to perform some other function. It can be challenging to provide a mechanical connection between the rotating mechanical component and the other component(s) of the larger device or system.

### SUMMARY

In some aspects, the techniques described herein relate to a magnetic coupling including: a first rotor including a first magnetic material including a first plurality of pole pairs disposed about a rotational axis; and a second rotor including a second magnetic material different from the first magnetic material, the second magnetic material including a second plurality of pole pairs disposed about the rotational axis, the first and second plurality of pole pairs magnetically coupled together such that rotation of the first rotor about the rotational axis imparts rotation of the second rotor about the rotational axis.

In some aspects, the techniques described herein relate to a magnetic coupling, wherein the first rotor includes an inner rotor and the second rotor includes an outer rotor, the inner rotor disposed radially within the outer rotor.

In some aspects, the techniques described herein relate to a magnetic coupling, wherein the first rotor includes a proximal rotor and the second rotor includes a distal rotor, the first and second rotors disposed adjacent one another along the rotational axis.

In some aspects, the techniques described herein relate to a magnetic coupling, wherein the first rotor includes a generally conical outer surface with the first plurality of pole pairs disposed at or near the outer surface, wherein the second rotor includes a generally conical inner surface with the second plurality of pole pairs disposed at or near the inner surface, the outer and inner surfaces spaced apart by an air gap.

In some aspects, the techniques described herein relate to a magnetic coupling to 4, wherein, during operation of the magnetic coupling, rotation of the first rotor about the rotational axis by a first angle imparts rotation of the second rotor by a second angle that is substantially the same as the first angle.

In some aspects, the techniques described herein relate to a magnetic coupling, wherein the second angle is within 5% of the first angle.

In some aspects, the techniques described herein relate to a magnetic coupling wherein, during operation of the magnetic coupling, rotation of the first rotor about the rotational axis at a first rotational speed imparts rotation of the second rotor about the rotational axis at a second rotational speed that is substantially the same as the first rotational speed.

In some aspects, the techniques described herein relate to a magnetic coupling, wherein the second rotational speed is within 5% of the first rotational speed.

In some aspects, the techniques described herein relate to a magnetic coupling wherein the first magnetic material includes a first constituent magnetic material and a second constituent magnetic material.

In some aspects, the techniques described herein relate to a magnetic coupling, wherein at least one pole pair of the first plurality of pole pairs includes a first polarity region and a second polarity region having a different polarity from the first polarity region, the first polarity region including the first constituent magnetic material and the second polarity region including the second constituent magnetic material.

In some aspects, the techniques described herein relate to a magnetic coupling wherein the second magnetic material includes a third constituent magnetic material and a fourth constituent magnetic material.

In some aspects, the techniques described herein relate to a magnetic coupling, wherein at least one pole pair of the second plurality of pole pairs includes a third polarity region and a fourth polarity region having a different polarity from the third polarity region, the third polarity region including the third constituent magnetic material and the fourth polarity region including the fourth constituent magnetic material.

In some aspects, the techniques described herein relate to a mechanical device including: the magnetic coupling a first rotatable component configured to rotate about the rotational axis and connected to the first rotor; and a second rotatable component configured to rotate about the rotational axis and connected to the second rotor.

In some aspects, the techniques described herein relate to a mechanical device, wherein one of the first and second rotatable components is part of a reusable assembly, and wherein the other of the first and second rotatable components is part of a disposable assembly.

In some aspects, the techniques described herein relate to a magnetic coupling including: a first rotor including a plurality of pole pairs disposed about a rotational axis; and a second rotor including a plurality of ferromagnetic teeth, the first and second rotors magnetically coupled together such that the first rotor and the second rotor rotate about the rotational axis together at substantially the same rotational speed.

In some aspects, the techniques described herein relate to a magnetic coupling, wherein the first rotor includes an inner rotor and the second rotor includes an outer rotor, the inner rotor disposed radially within the outer rotor.

In some aspects, the techniques described herein relate to a magnetic coupling, wherein the first rotor includes a proximal rotor and the second rotor includes a distal rotor, the first and second rotors disposed adjacent one another along the rotational axis.

In some aspects, the techniques described herein relate to a magnetic coupling, wherein the first rotor includes a generally conical outer surface with the plurality of pole pairs disposed at or near the outer surface, wherein the second rotor includes a generally conical inner surface with the plurality of ferromagnetic teeth disposed at or near the inner surface, the outer and inner surfaces spaced apart by an air gap.

In some aspects, the techniques described herein relate to a magnetic coupling wherein rotation of the first and second rotors is coupled by magnetic reluctance.

In some aspects, the techniques described herein relate to a magnetic coupling to wherein, during operation of the magnetic coupling, rotation of the first rotor about the rotational axis by a first angle imparts rotation of the second rotor by a second angle that is substantially the same as the first angle.

In some aspects, the techniques described herein relate to a magnetic coupling, wherein the second angle is within 5% of the first angle.

In some aspects, the techniques described herein relate to a magnetic coupling wherein, during operation of the magnetic coupling, rotation of the first rotor about the rotational axis at a first rotational speed imparts rotation of the second rotor about the rotational axis at a second rotational speed that is substantially the same as the first rotational speed, wherein the second rotational speed is within 5% of the first rotational speed.

In some aspects, the techniques described herein relate to a magnetic coupling wherein at least one pole pair of the plurality of pole pairs includes a first polarity region and a second polarity region having a different polarity from the first polarity region, the first and second polarity regions being formed of different materials.

In some aspects, the techniques described herein relate to a mechanical device including: the magnetic coupling a first rotatable component configured to rotate about the rotational axis and connected to the first rotor; and a second rotatable component configured to rotate about the rotational axis and connected to the second rotor.

In some aspects, the techniques described herein relate to a mechanical device, wherein one of the first and second rotatable components is part of a reusable assembly, and wherein the other of the first and second rotatable components is part of a disposable assembly.

In some aspects, the techniques described herein relate to a magnetic coupling including: a first rotor including a plurality of permanent magnets spaced apart by ferromagnetic teeth, the plurality of permanent magnets disposed about a rotational axis; and a second rotor including a plurality of pole pairs disposed about the rotational axis, the first and second rotors magnetically coupled together such that the first rotor and the second rotor rotate about the rotational axis together at substantially the same rotational speed.

In some aspects, the techniques described herein relate to a magnetic coupling, wherein the first rotor includes an inner rotor and the second rotor includes an outer rotor, the inner rotor disposed radially within the outer rotor.

In some aspects, the techniques described herein relate to a magnetic coupling, wherein the first rotor includes a proximal rotor and the second rotor includes a distal rotor, the first and second rotors disposed adjacent one another along the rotational axis.

In some aspects, the techniques described herein relate to a magnetic coupling, wherein the first rotor includes a generally conical outer surface with the plurality of permanent magnets disposed at or near the outer surface, wherein the second rotor includes a generally conical inner surface with the plurality of pole pairs disposed at or near the inner surface, the outer and inner surfaces spaced apart by an air gap.

In some aspects, the techniques described herein relate to a magnetic coupling wherein, during operation of the magnetic coupling, rotation of the first rotor about the rotational axis by a first angle imparts rotation of the second rotor by a second angle that is substantially the same as the first angle.

In some aspects, the techniques described herein relate to a magnetic coupling, wherein the second angle is within 5% of the first angle.

In some aspects, the techniques described herein relate to a magnetic coupling wherein, during operation of the magnetic coupling, rotation of the first rotor about the rotational axis at a first rotational speed imparts rotation of the second rotor about the rotational axis at a second rotational speed that is substantially the same as the first rotational speed, wherein the second rotational speed is within 5% of the first rotational speed.

In some aspects, the techniques described herein relate to a magnetic coupling to wherein at least one pole pair of the plurality of pole pairs includes a first polarity region and a second polarity region having a different polarity from the first polarity region, the first and second polarity regions being formed of different materials.

In some aspects, the techniques described herein relate to a mechanical device including: the magnetic coupling a first rotatable component configured to rotate about the rotational axis and connected to the first rotor; and a second rotatable component configured to rotate about the rotational axis and connected to the second rotor.

In some aspects, the techniques described herein relate to a mechanical device, wherein one of the first and second rotatable components is part of a reusable assembly, and wherein the other of the first and second rotatable components is part of a disposable assembly.

In some aspects, the techniques described herein relate to a mechanical device including: a magnetic coupling including a first rotor and a second rotor magnetically coupled with the first rotor, at least one of the first and second rotors having a plurality of magnetic pole pairs disposed about a rotational axis; a first rotatable component configured to rotate about the rotational axis and connected to the first rotor; and a second rotatable component configured to rotate about the rotational axis and connected to the second rotor, wherein, during operation of the mechanical device, the magnetic coupling causes the first and second rotatable components to rotate at substantially the same rotational speed.

In some aspects, the techniques described herein relate to a mechanical device, wherein one of the first and second rotatable components is part of a reusable assembly, and wherein the other of the first and second rotatable components is part of a disposable assembly.

In some aspects, the techniques described herein relate to a mechanical device, wherein the magnetic coupling includes a radial magnetic coupling, an axial magnetic coupling, or a conical magnetic coupling.

In some aspects, the techniques described herein relate to a mechanical device further including a barrier separating the first and second rotors.

### BRIEF DESCRIPTION OF THE DRAWINGS

FIG. 1A is a view of an embodiment of a mechanical system comprising a magnetic coupling.

FIG. 1B is a view of an embodiment of a mechanical system comprising a magnetic coupling.

FIG. 2A is a view of an embodiment of a radial magnetic coupling system.

FIG. 2B is a view of an embodiment of an axial magnetic coupling system.

FIG. 3A is a view of an embodiment of a magnetic coupling system.

FIG. 3B is a view of an embodiment of a magnetic coupling system.

FIG. 4A is a view of an embodiment of a magnetic coupling system.

FIG. 4B is a view of an embodiment of a magnetic coupling system.

FIG. 5 is a view of an embodiment of a magnetic coupling system.

### DETAILED DESCRIPTION

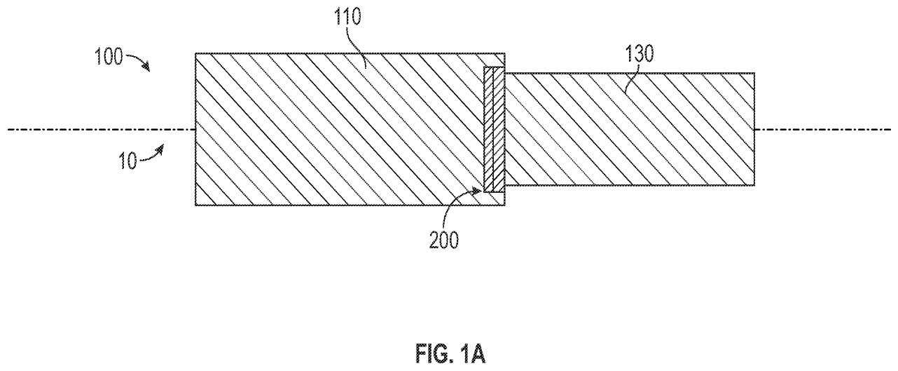

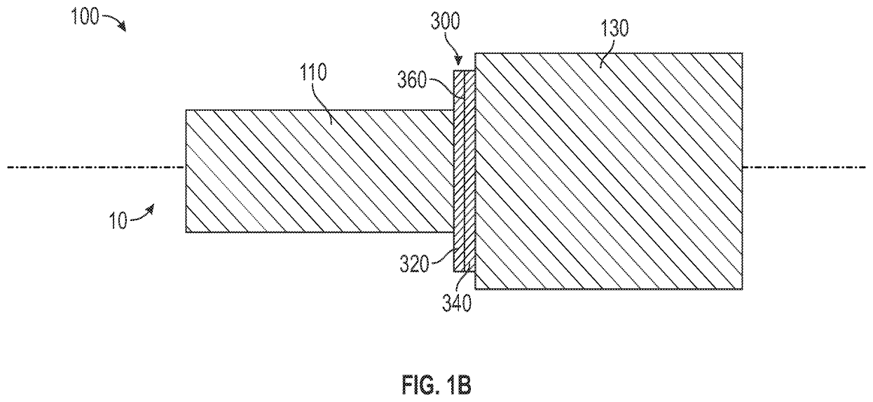

In various types of mechanical devices, it can be challenging to rotatably couple different components. For example, in some applications, a first rotatable component may be part of a reusable assembly in which the first component is reused multiple times, while a second rotatable component may be part of a disposable assembly in which the second component is used a single time, or a limited number of times. As an example, in various types of medical devices, the first rotatable component (e.g., a reusable component) can be part of a motor or other actuator that is disposed outside the patient and connected to a control system, such as a console. The second rotatable component (e.g., a disposable component) can be part of, or connected to, a working end of the medical device, such as a pump, a sensing device, an ablation or cutting device, etcetera. The mechanical device may comprise a connector (e.g., latch, connector, attachment) that removably connects the two parts, the first rotatable component and the second rotatable component. There may further be a barrier separating the first rotatable component and the second rotatable component. The first reusable rotor may be connected to a first disposable rotor, and the first reusable rotor (the first rotatable component) may be a different material than the first disposable rotor (the second rotatable component). As such, the drive rotor or the rotor which is driven may be replaced (e.g., after operation of the device, disconnect the reusable rotor from the first disposable rotor by, e.g., disengaging the connector; connect the reusable rotor to a second disposable rotor that can be structurally the same as or substantially similar to the first disposable rotor (or the second disposable rotor can be structurally different from the first reusable rotor in some embodiments); operate the device with the second disposable rotor). As shown in FIGS. 1A-1B, in some embodiments, a mechanical barrier can separate the first and second components. In some embodiments, the barrier can separate first and second rotors of a magnetic coupling.

In various embodiments, it can be challenging to integrate magnetic couplings in devices that utilize such barriers in an economical and efficient manner. For example, for implementations in which the second component is disposable, the use of expensive components and materials in the second component can undesirably increase the overall costs of the system (e.g., over the lifetime of the system). Further, in embodiments in which a barrier separates first and second rotors, it may be challenging to create an adequate mechanical coupling between the first and second components. Accordingly, as shown in FIGS. 1A-1B, in various embodiments, a magnetic coupling can be provided to provide a mechanical connection between the first and second rotatable components, in which a barrier is disposed between the first and second rotatable components (e.g., between the first and second rotors).

FIGS. 1A and 1B illustrate embodiments of the mechanical system 100. The mechanical system 100 can include a mechanical barrier 150, not shown in 1A, which can separate the first component 110 and second component 130. In some embodiments, the barrier can separate first and second rotors of a magnetic coupling.

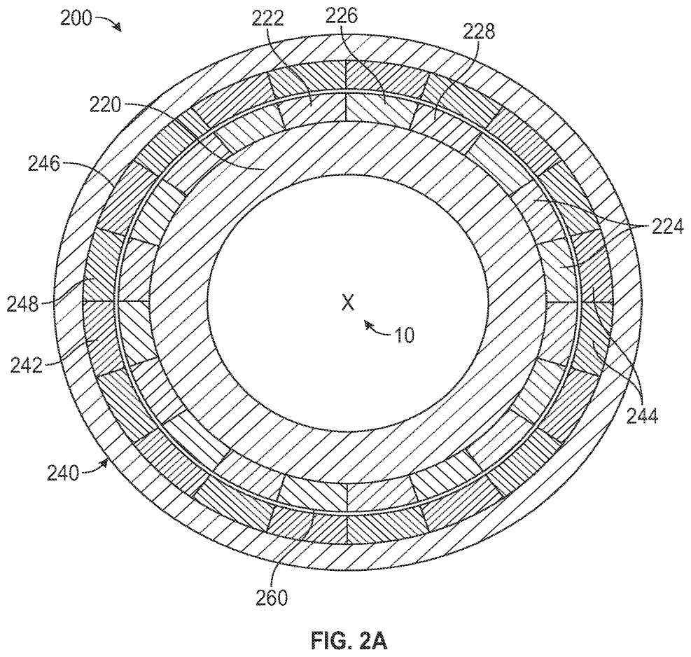

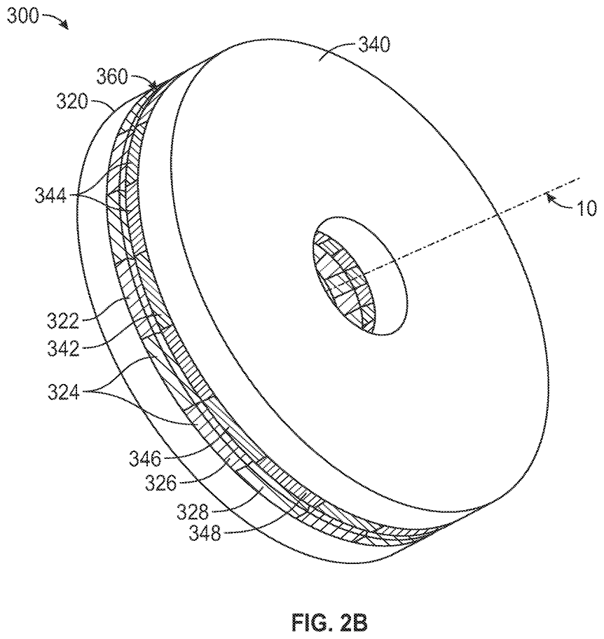

FIG. 1A illustrates an embodiment of the mechanical system 100 comprising a radial magnetic coupling system 200 (shown in FIG. 2A) in which a first inner rotor 220 is disposed radially within a second outer rotor 240. The mechanical system 100 can further include a first component 110 and a second component 130. The first component 110 can be coupled to the first inner rotor 220 or the second outer rotor 240 of the radial magnetic coupling system 200. The second component 130 can be connected first inner rotor 220 or second outer rotor 240, whichever is not connected to first component 110. The radial magnetic coupling system 200 can include a barrier 260 between the first inner rotor 220 and the second outer rotor 240 (shown in FIG. 2A). The barrier 260 may be a solid barrier or may be an air gap. In various embodiments, the magnetic coupling systems 200 can cause synchronous rotation, e.g., a 1:1 rotation between the first component 110 and the second component 130, via first inner rotor 220 and second outer rotor 240. Moreover, the first component 110, the first inner rotor 220, the second component 130, and the second outer rotor 240 can rotate about a common rotational axis 10. Thus, the first inner rotor 220 and second outer rotor 240 of the radial magnetic coupling system 200 can rotate about a single rotational axis 10 (e.g., synchronous rotation).

FIG. 1B illustrates an embodiment of the mechanical system 100 comprising an axial magnetic coupling system 300 in which first magnetic rotor 320 and second magnetic rotor 340 are disposed laterally adjacent to one another, e.g., adjacent along a longitudinal or rotational axis of the system 100. The mechanical system 100 can further include a first component 110 and a second component 130. The first component 110 can be coupled to the first magnetic rotor 320 or the second magnetic rotor 340 of the radial magnetic coupling system 200. The second component 130 can be connected first magnetic rotor 320 or second magnetic rotor 340, whichever is not connected to first component 110. The radial magnetic coupling system 300 can include a barrier 360 between the second magnetic rotor 340 and first magnetic rotor 320. In various embodiments, the magnetic coupling systems 300 can cause synchronous rotation, e.g., a 1:1 rotation between the first component 110 and the second component 130, via the first magnetic rotor 320 and second magnetic rotor 340. Moreover, the first component 110, first magnetic rotor 320, the second component 130, and the second magnetic rotor 340 can rotate about a common rotational axis 10. Thus, the first magnetic rotor 320 and the second magnetic rotor 340 of the radial magnetic coupling system 200 can rotate about a single rotational axis 10 (e.g., synchronous rotation).

FIG. 2A is an example of a radial magnetic coupling system 200 in which the coupling can include a plurality of different magnetic materials. The radial magnetic coupling system 200 can include a first inner rotor 220 comprising a first magnetic material 222 including a first plurality of pole pairs 224 disposed about a rotational axis 10. The first plurality of pole pairs 224 can include a first polarity region 226 and a second polarity region 228. The first magnetic material 222 may sit on the outside of the first inner rotor 220. The first plurality of pole pairs 224 can comprise an alternating pattern of the first polarity region 226 and second polarity region 228. The radial magnetic coupling system 200 can include a second outer rotor 240 that surrounds or at least partially surrounds the first inner rotor 220 the second outer rotor 240 can comprising a second magnetic material 242 including a second plurality of pole pairs 244 disposed about a rotational axis 10. The second magnetic material 242 can be different than the first magnetic material 222. The second plurality of pole pairs 244 can include a first polarity region 246 and a second polarity region 248. The first magnetic material 242 may sit on the inside of the first inner rotor 240, such that it faces the first magnetic material 222 on the outside of first inner rotor 220. The second plurality of pole pairs 244 can comprise an alternating pattern of the first polarity region 246 and second polarity region 248. The first plurality of pole pairs 224 and the second plurality of pole pairs 244 can be magnetically coupled together such that rotation of the first magnetic rotor 320 about the rotational axis 10 imparts rotation of the second magnetic rotor 340 about the rotational axis 10.

The radial magnetic coupling system 200 can include a barrier 260 between the first inner rotor 220 and the second outer rotor 240. The barrier 260 may be a solid barrier or may be an air gap. The barrier may seal the first rotor 220 or the second rotor 240 such that element including water, air, germs, fluids, or other things can not contact or transfer between the rotors. Any airgap shown or mention can be a barrier and any barrier can be an air gap in certain embodiments.

FIG. 2B is an example of an axial magnetic coupling system 300 in which the coupling can include a plurality of different magnetic materials. The axial magnetic coupling system 300 can include first magnetic rotor 320 comprising a first magnetic material 322 including a first plurality of pole pairs 324 disposed about a rotational axis 10. The first plurality of pole pairs 324 can include a first polarity region 326 and a second polarity region 328. The first magnetic material 322 may sit on a first side of the first magnetic rotor 320. The first plurality of pole pairs 324 can comprise an alternating pattern of the first polarity region 326 and second polarity region 328. The radial magnetic coupling system 300 can include a second magnetic rotor 340 that is adjacent to and shares a rotational axis 10 with the first magnetic rotor 320. The second magnetic rotor 340 can comprising a second magnetic material 342 including a second plurality of pole pairs 344 disposed about a rotational axis 10. The second magnetic material 342 can be different than the first magnetic material 322. The second plurality of pole pairs 344 can include a third polarity region 346 and a second polarity region 248. The second magnetic material 342 may sit on a first side of the second magnetic rotor 340, such that it faces the first magnetic material 322 on the first side of first magnetic rotor 320. The second plurality of pole pairs 344 can comprise an alternating pattern of the first polarity region 246 and fourth polarity region 348. The first plurality of pole pairs 324 and the second plurality of pole pairs 344 can be magnetically coupled together such that rotation of the first magnetic rotor 320 about the rotational axis 10 imparts rotation of the second magnetic rotor 340 about the rotational axis 10.

The axial magnetic coupling system 300 can include a barrier 360 between the first rotor 320 and the second rotor 340. The barrier 360 may be a solid barrier or may be an air gap. The barrier may seal the first rotor 320 or the second rotor 340 such that element including water, air, germs, fluids, or other things can not contact or transfer between the rotors. Any airgap shown or mention can be a barrier and any barrier can be an air gap in certain embodiments. The barrier 260, 360 can be a nonmagnetic material, and can be a nonconductive material. In some embodiments, the barrier 260, 360 can include a high strength thermoplastic or thermoset material. For example, the barrier 260, 360 can include an epoxy resin or PEEK.

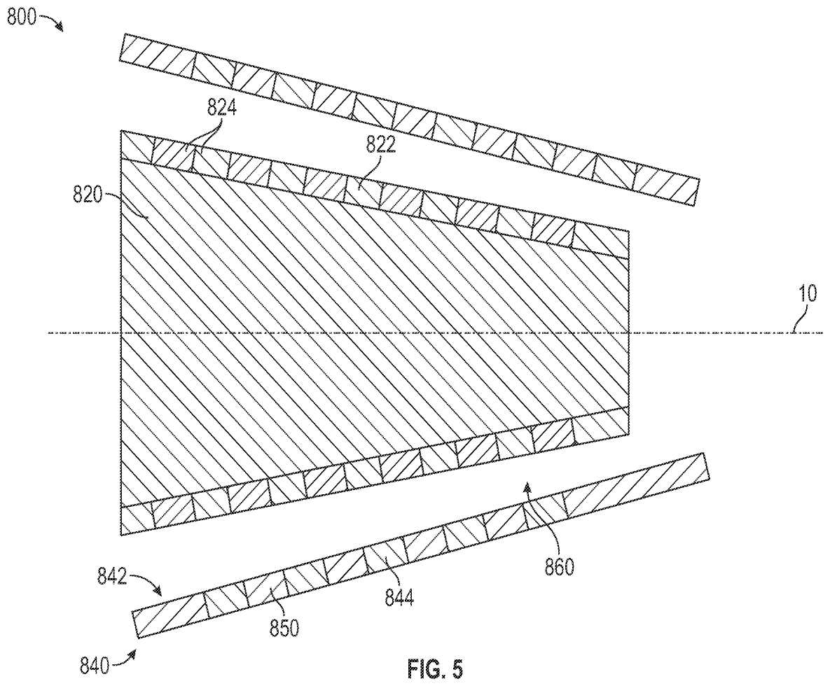

As shown in FIG. 2A, in some embodiments, the first rotor 220 comprises an inner rotor and the second rotor 240 comprises an outer rotor, the inner rotor disposed radially within the outer rotor. As shown in FIG. 2A, in other embodiments, the first rotor 220 comprises a proximal rotor and the second rotor 240 comprises a distal rotor. The first and second rotors 220,240 can be disposed adjacent one another along the rotational axis 10. In still other embodiments, as shown in FIG. 5, the first rotor 820 can comprise a generally conical outer surface 822 with the first plurality of pole pairs 824 disposed at or near the outer surface 822. As shown in FIG. 5, the second rotor 840 can comprise a generally conical inner surface 842 with the second plurality of pole pairs 844 disposed at or near the inner surface 842, the outer and inner surfaces spaced apart by an air gap 860. The generally conical inner and outer surfaces 842,822 can comprise a conical surface, a frustonical surface, or other tapered surfaces. The conical air gap 860 can be beneficial in various embodiments for coupling across solid barriers and for improving magnetic performance (e.g., increasing effective air gap surface area).

In various embodiments, during operation of the magnetic coupling, rotation of the first rotor 220, 320 about the rotational axis 10 by a first angle imparts rotation of the second rotor 240, 340 by a second angle that is substantially the same as the first angle. For example, in various embodiments, the second angle can be within 10%, within 5%, or within 1% of the first angle. In various embodiments, during operation of the magnetic coupling, rotation of the first rotor 220, 320 about the rotational axis at a first rotational speed imparts rotation of the second rotor 240,340 about the rotational axis at a second rotational speed that is substantially the same as the first rotational speed. For example, in various embodiments, the second rotational speed can be within 10%, within 5%, or within 1% of the first rotational speed.

In some embodiments, the first magnetic material 222, 322 comprises a first constituent magnetic material and a second constituent magnetic material. In some embodiments, the first and second constituent magnetic materials can comprise different materials. At least one pole pair of the first plurality of pole pairs 224, 324 includes a first polarity region 226, 326 and a second polarity region 228, 328 having a different polarity from the first polarity region 226, 326. In some embodiments, the first polarity region 226, 326 can comprise the first constituent magnetic material and the second polarity region 228, 328 can comprise the second constituent magnetic material. In other embodiments, the first polarity region 226, 228 and second polarity region 228, 328 within the first rotor 220, 320 can comprise the same magnetic material.

In some embodiments, the second magnetic material 242, 342 can include a third constituent magnetic material and a fourth constituent magnetic material. In some embodiments, the third and fourth constituent magnetic materials can comprise different materials. For example, at least one pole pair of the second plurality of pole pairs 244, 344 can include a third polarity region 246, 346 and a fourth polarity region 248, 348 having a different polarity from the third polarity region 246, 346. In some embodiments, the third polarity region 246, 346 can comprise the third constituent magnetic material and the fourth polarity region 248, 348 comprising the fourth constituent magnetic material. In other embodiments, the third polarity region 246, 346 and fourth polarity region 248, 348 within the second rotor 240, 340 can comprise the same magnetic material.

Beneficially, in some embodiments, less expensive magnetic materials can be provided in a disposable assembly, while more expensive magnetic materials can be provided in the reusable assembly. By reusing the materials that are more expensive, various embodiments disclosed herein can reduce overall costs of the mechanical device. For example, in various embodiments, the magnetic material for the disposable component(s) can comprise a relatively inexpensive material, such as ferrite magnets, aluminum-nickel-cobalt (AlNiCo) magnets, iron nitride magnets, or manganese bismuth (MnBi) magnets. In some embodiments, the magnetic material(s) for the reusable component(s) can comprise a higher performance magnetic material, such as neodymium-iron-boron (NdFeB) magnets, samarium-cobalt magnets, and other high performance materials which may be more expensive than magnets used for the disposable component(s). Any one of the first component 110 or second component 130 may be the reusable component or the disposable components, and as such, the materials discussed above by be used on the rotor connected to either the first component 110 or second component 130.

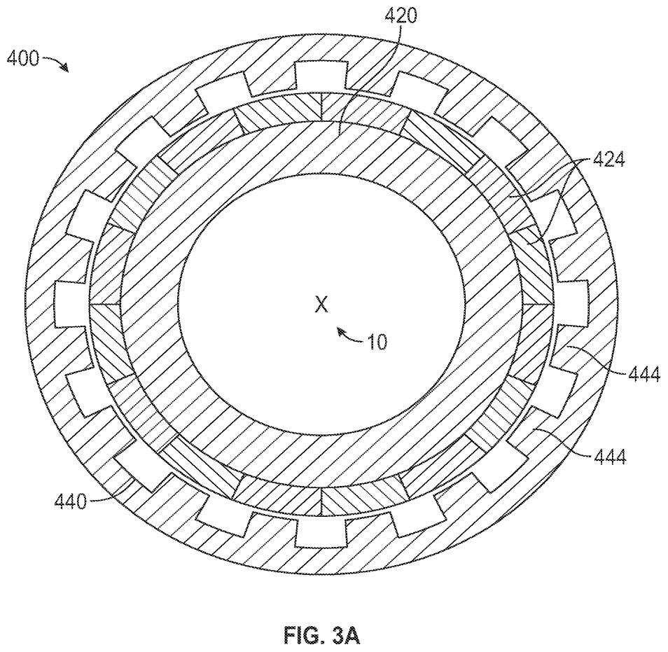

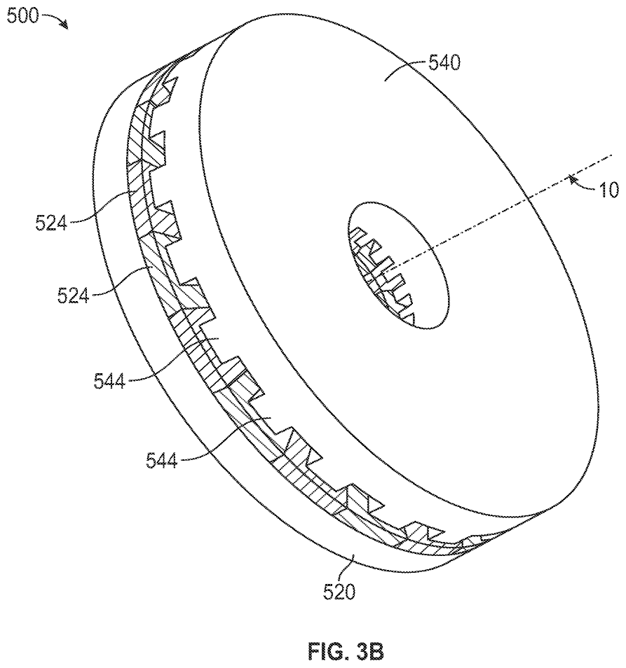

FIGS. 3A, illustrate an embodiment, of a magnetic coupling system 400. The magnetic coupling system 400 can include or share any attribute or component of the radial magnetic coupling system 200, and vice versa. The magnetic coupling system 400 can include a first rotor 420 comprising a plurality of pole pairs 224 disposed about a rotational axis 10, and a second rotor 440 comprising a plurality of ferromagnetic teeth 444. The first rotor 420 and second rotor 440 can be magnetically coupled together such that the first rotor 420 and the second rotor 440 rotate about the rotational axis 10 together at substantially the same rotational speed. As shown in FIG. 3A, in some embodiments, the first rotor 420 comprises an inner rotor and the second rotor 440 comprises an outer rotor, the inner rotor disposed radially within the outer rotor. In other embodiments, the second rotor 440 with the ferromagnetic teeth 444 can be disposed radially within the first rotor 420 with magnetic pole pairs 424.

FIGS. 3B, illustrate an embodiment, of a magnetic coupling system 500. The magnetic coupling system 500 can include or share any attribute or component of the axial magnetic coupling system 300, and vice versa. The magnetic coupling system 500 can include a first rotor 520 comprising a plurality of pole pairs 524 disposed about a rotational axis 10, and a second rotor 540 comprising a plurality of ferromagnetic teeth 544. The first rotor 520 and second rotor 540 can be magnetically coupled together such that the first rotor 520 and the second rotor 540 rotate about the rotational axis 10 together at substantially the same rotational speed. As shown in FIG. 3B, the first rotor 520 comprises a proximal rotor and the second rotor 540 comprises a distal rotor, the first rotor 520 and second rotor 540 disposed adjacent one another along the rotational axis 10. In still other embodiments, as shown schematically in FIG. 5, the first rotor comprises a generally conical outer surface 822 with the plurality of pole pairs disposed at or near the outer surface 822. As shown in FIG. 5, the second rotor can comprise a generally conical inner surface with the plurality of ferromagnetic teeth disposed at or near the inner surface, the outer and inner surfaces spaced apart by an air gap.

In the embodiment of FIGS. 3A-3B, rotation of the first and second rotors can be coupled by magnetic reluctance. For example, in various embodiments, the first rotor's 420,520 pole pairs 424, 524 may couple to a second reluctance rotor made of a soft magnetic material, where the second rotor 440,540 comprises or is defined by the second reluctance rotor. The reluctance rotor may possess salient features or non-salient features to achieve varying magnetic reluctance. For example, for the radial magnetic coupler 400 of FIG. 3A, the second reluctance rotor can comprise a laminated electrical steel material. For the axial magnetic coupler 500 of FIG. 3B, the second reluctance rotor can comprise a soft magnetic composite material or a tape-wound electrical steel laminate. In various embodiments, during operation of the magnetic coupling, rotation of the first rotor 420, 520 about the rotational axis 10 by a first angle imparts rotation of the second rotor 440, 540 by a second angle that is substantially the same as the first angle, as noted above in connection with FIGS. 2A-2B. For example, in various embodiments, the second angle can be within 10%, within 5%, or within 1% of the first angle. In various embodiments, during operation of the magnetic coupling, rotation of the first rotor 420, 520 about the rotational axis 10 at a first rotational speed imparts rotation of the second rotor 440, 540 about the rotational axis at a second rotational speed that is substantially the same as the first rotational speed. For example, in various embodiments, the second rotational speed can be within 10%, within 5%, or within 1% of the first rotational speed.

Beneficially, in various embodiments, the second rotor 440, 540 with the ferromagnetic teeth can be disposed in the disposable assembly. In some arrangements, the material for the ferromagnetic teeth 444, 544 may be more expensive and/or less complex to manufacture than the first rotor with the magnetic poles. Accordingly, disposing the second rotor 440, 540 with the ferromagnetic teeth 444, 544 in the disposable assembly can reduce overall device costs.

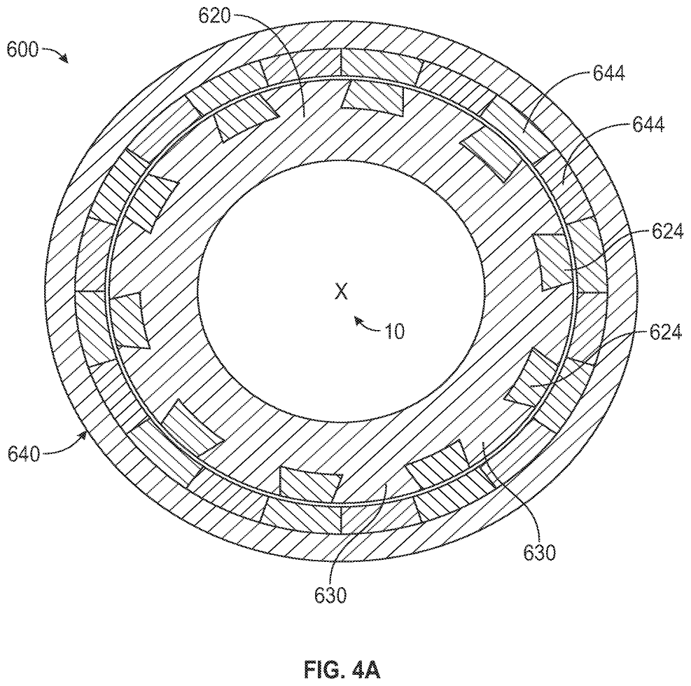

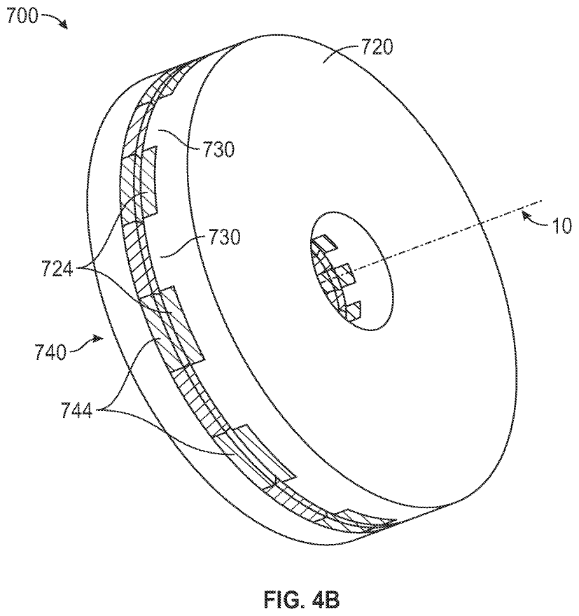

FIG. 4A illustrate an embodiment of a magnetic coupling system 600. The magnetic coupling system 600 may share any attribute or component of the radial magnetic coupling system 200 or the magnetic coupling system 400, and vise versa. The magnetic coupling system 600 can include a first rotor 620 comprising a plurality of permanent magnets 624 spaced apart by ferromagnetic teeth 630. The plurality of permanent magnets 624 can be disposed about a rotational axis 10. The ferromagnetic teeth 630 can comprise consequent pole regions with polarity induced by the permanent magnets 624 disposed in the first rotor. For example, the consequent pole regions of the ferromagnetic teeth 630 can be magnetized by the permanent magnets 624 without contribution from the second rotor 640. Flux from adjacent permanent magnets 624 in the first rotor can magnetize the intervening ferromagnetic teeth regions 630 that are disposed between the adjacent permanent magnets 624. The magnetic coupling can further include a second rotor 640 comprising a plurality of pole pairs 644 disposed about the rotational axis. The first rotor 620 and second rotor 640 can be magnetically coupled together such that the first rotor 620 and the second rotor 640 rotate about the rotational axis 10 together at substantially the same rotational speed. In some embodiments, as shown in FIG. 4A, the first rotor 620 comprises an inner rotor and the second rotor 640 comprises an outer rotor, the inner rotor disposed radially within the outer rotor. In other embodiments, the second rotor 640 can be disposed radially within the first rotor 620.

FIG. 4B illustrate an embodiment of a magnetic coupling system 700. The magnetic coupling system 700 may share any attribute or component of the axial magnetic coupling system 300 or the magnetic coupling system 500, and vice versa. The magnetic coupling system 700 can include a first rotor 720 comprising a plurality of permanent magnets 724 spaced apart by ferromagnetic teeth 730. The plurality of permanent magnets 724 can be disposed about a rotational axis 10. The ferromagnetic teeth 730 can comprise consequent pole regions with polarity induced by the permanent magnets 724 disposed in the first rotor. For example, the consequent pole regions of the ferromagnetic teeth 730 can be magnetized by the permanent magnets 724 without contribution from the second rotor 740. Flux from adjacent permanent magnets 724 in the first rotor can magnetize the intervening ferromagnetic teeth regions 730 that are disposed between the adjacent permanent magnets 724. The magnetic coupling can further include a second rotor 740 comprising a plurality of pole pairs 744 disposed about the rotational axis. The first rotor 720 and second rotor 740 can be magnetically coupled together such that the first rotor 720 and the second rotor 740 rotate about the rotational axis 10 together at substantially the same rotational speed. In some embodiments, as shown in FIG. 4B, the first rotor 720 comprises a proximal rotor and the second rotor 740 comprises a distal rotor, the first rotor 720 and second rotor 740 disposed adjacent one another along the rotational axis. In still other embodiments, as shown in FIG. 5, the first rotor comprises a generally conical outer surface 822 with the plurality of permanent magnets disposed at or near the outer surface 822, and the second rotor comprises a generally conical inner surface with the plurality of pole pairs disposed at or near the inner surface, with the outer and inner surfaces spaced apart by an air gap.

In various embodiments, during operation of the magnetic coupling, rotation of the first rotor 620, 720 about the rotational axis 10 by a first angle imparts rotation of the second rotor 640, 740 by a second angle that is substantially the same as the first angle. The second angle can be within 10%, within 5%, or within 1% of the first angle. In various embodiments, during operation of the magnetic coupling, rotation of the first rotor 620, 720 about the rotational axis at a first rotational speed imparts rotation of the second rotor 640, 740 about the rotational axis at a second rotational speed that is substantially the same as the first rotational speed. For example, in various embodiments, the second rotational speed can be within 10%, within 5%, or within 1% of the first rotational speed.

FIG. 5 illustrates an embodiment of a magnetic coupling system 800. The magnetic coupling system 800 may share any attribute or component of the magnetic coupling systems 200-700, and vice versa. The magnetic coupling system 800 can include a first rotor 820 and a second rotor 840. The first rotor 820 can comprise a generally conical outer surface 822 with the plurality of pole pairs 824 disposed at or near the outer surface 822. The second rotor 840 can comprise a generally conical inner surface 842 with the plurality of ferromagnetic teeth 850 disposed at or near the inner surface 842, the outer surface 822 and inner surfaces 842 spaced apart by an air gap 860. The ferromagnetic teeth 850 can comprise consequent pole regions with polarity induced by the permanent magnets 844 disposed in the first rotor. For example, the consequent pole regions of the ferromagnetic teeth 850 can be magnetized by the permanent magnets 844 without contribution from the first rotor 820. Flux from adjacent permanent magnets 844 in the first rotor can magnetize the intervening ferromagnetic teeth regions 850 that are disposed between the adjacent permanent magnets 844. The first rotor 820 and second rotor 840 can be magnetically coupled together such that the first rotor 820 and the second rotor 840 rotate about the rotational axis 10 together at substantially the same rotational speed.

Beneficially, in various embodiments, the first rotor, which includes fewer magnets than the second rotor, may be more expensive than (or more complex to manufacture as compared to) the second rotor. Accordingly, in some embodiments, providing the first rotor in the disposable assembly can reduce overall device costs.

In the embodiments disclosed herein, the magnets (e.g., the pole pairs) can comprise a permanent magnet or an electromagnet on one rotor with an induction configuration (e.g., windings bars, or a cage) on the other rotor.

In the embodiments disclosed herein, the magnetic coupling 200-800 may comprise a barrier or an air gap between a first rotor and a second rotor. The barrier may seal the first rotor or the second rotor such that element including water, air, germs, fluids, or other things can not contact or transfer between the rotor. Any airgap shown or mention can be a barrier and any barrier can be an air gap in certain embodiments.

In the foregoing specification, the systems and processes have been described with reference to specific embodiments thereof. It will, however, be evident that various modifications and changes may be made thereto without departing from the broader spirit and scope of the embodiments disclosed herein. The specification and drawings are, accordingly, to be regarded in an illustrative rather than restrictive sense.

Indeed, although the systems and processes have been disclosed in the context of certain embodiments and examples, it will be understood by those skilled in the art that the various embodiments of the systems and processes extend beyond the specifically disclosed embodiments to other alternative embodiments and/or uses of the systems and processes and obvious modifications and equivalents thereof. In addition, while several variations of the embodiments of the systems and processes have been shown and described in detail, other modifications, which are within the scope of this disclosure, will be readily apparent to those of skill in the art based upon this disclosure. It is also contemplated that various combinations or sub-combinations of the specific features and embodiments of the embodiments may be made and still fall within the scope of the disclosure. It should be understood that various features and embodiments of the disclosed embodiments can be combined with, or substituted for, one another in order to form varying modes of the embodiments of the disclosed systems and processes. Any methods disclosed herein need not be performed in the order recited. Thus, it is intended that the scope of the systems and processes herein disclosed should not be limited by the particular embodiments described above.

It will be appreciated that the systems and methods of the disclosure each have several innovative embodiments, no single one of which is solely responsible or required for the desirable attributes disclosed herein. The various features and processes described above may be used independently of one another or may be combined in various ways. All possible combinations and sub-combinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination. No single feature or group of features is necessary or indispensable to each and every embodiment.

It will also be appreciated that conditional language used herein, such as, among others, “can,” “could,” “might,” “may,” “for example,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. In addition, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one or more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. Additionally, other embodiments are within the scope of the following claims. In some cases, the actions recited in the claims may be performed in a different order and still achieve desirable results.

Further, while the methods and devices described herein may be susceptible to various modifications and alternative forms, specific examples thereof have been shown in the drawings and are herein described in detail. It should be understood, however, that the embodiments are not to be limited to the particular forms or methods disclosed, but, to the contrary, the embodiments are to cover all modifications, equivalents, and alternatives falling within the spirit and scope of the various implementations described and the appended claims. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (for example, as accurate as reasonably possible under the circumstances, for example ±5%, ±10%, ±15%, etc.). For example, “about 3.5 mm” includes “3.5 mm.” Phrases preceded by a term such as “substantially” include the recited phrase and should be interpreted based on the circumstances (for example, as much as reasonably possible under the circumstances). For example, “substantially constant” includes “constant.” Unless stated otherwise, all measurements are at standard conditions including temperature and pressure.

1.-39. (canceled)

40. A magnetic coupling comprising:
a first rotor comprising a first magnetic material including a first plurality of pole pairs disposed about a rotational axis; and
a second rotor comprising a second magnetic material different from the first magnetic material, the second magnetic material including a second plurality of pole pairs disposed about the rotational axis, the first and second plurality of pole pairs magnetically coupled together such that rotation of the first rotor about the rotational axis imparts rotation of the second rotor about the rotational axis during operation of the magnetic coupling.

41. The magnetic coupling of claim 40, wherein the first rotor comprises an inner rotor and the second rotor comprises an outer rotor, the inner rotor disposed radially within the outer rotor.

42. The magnetic coupling of claim 40, wherein the first rotor comprises a proximal rotor and the second rotor comprises a distal rotor, the first and second rotors disposed adjacent one another along the rotational axis.

43. The magnetic coupling of claim 40, wherein the first rotor comprises a conical outer surface with the first plurality of pole pairs disposed at or near the outer surface, wherein the second rotor comprises a conical inner surface with the second plurality of pole pairs disposed at or near the inner surface, the outer and inner surfaces spaced apart by an air gap.

44. The magnetic coupling of claim 40, wherein, during operation of the magnetic coupling, rotation of the first rotor about the rotational axis by a first angle imparts rotation of the second rotor by a second angle that is substantially the same as the first angle.

45. The magnetic coupling of claim 40, wherein, during operation of the magnetic coupling, rotation of the first rotor about the rotational axis at a first rotational speed imparts rotation of the second rotor about the rotational axis at a second rotational speed that is substantially the same as the first rotational speed.

46. The magnetic coupling of claim 40, wherein the first magnetic material comprises a first constituent magnetic material and a second constituent magnetic material, and wherein at least one pole pair of the first plurality of pole pairs includes a first polarity region and a second polarity region having a different polarity from the first polarity region, the first polarity region comprising the first constituent magnetic material and the second polarity region comprising the second constituent magnetic material.

47. The magnetic coupling of claim 40, wherein the second magnetic material comprises a third constituent magnetic material and a fourth constituent magnetic material, and wherein at least one pole pair of the second plurality of pole pairs includes a third polarity region and a fourth polarity region having a different polarity from the third polarity region, the third polarity region comprising the third constituent magnetic material and the fourth polarity region comprising the fourth constituent magnetic material.

48. The magnetic coupling of claim 40, further comprising:
a first rotatable component configured to rotate about the rotational axis and connected to the first rotor; and
a second rotatable component configured to rotate about the rotational axis and connected to the second rotor.

49. The magnetic coupling of claim 48, wherein one of the first and second rotatable components is part of a reusable assembly, and wherein the other of the first and second rotatable components is part of a disposable assembly.

50. A magnetic coupling comprising:
a first rotor comprising a plurality of pole pairs disposed about a rotational axis; and
a second rotor comprising a plurality of ferromagnetic teeth, the first and second rotors magnetically coupled together such that the first rotor and the second rotor rotate about the rotational axis together at substantially the same rotational speed.

51. The magnetic coupling of claim 50, wherein the first rotor comprises an inner rotor and the second rotor comprises an outer rotor, the inner rotor disposed radially within the outer rotor.

52. The magnetic coupling of claim 50, wherein the first rotor comprises a proximal rotor and the second rotor comprises a distal rotor, the first and second rotors disposed adjacent one another along the rotational axis.

53. The magnetic coupling of claim 50, wherein the first rotor comprises a conical outer surface with the plurality of pole pairs disposed at or near the outer surface, wherein the second rotor comprises a conical inner surface with the plurality of ferromagnetic teeth disposed at or near the inner surface, the outer and inner surfaces spaced apart by an air gap.

54. The magnetic coupling of claim 50, wherein at least one pole pair of the plurality of pole pairs includes a first polarity region and a second polarity region having a different polarity from the first polarity region, the first and second polarity regions being formed of different materials.

55. The magnetic coupling of claim 50, further comprising:
a first rotatable component configured to rotate about the rotational axis and connected to the first rotor; and
a second rotatable component configured to rotate about the rotational axis and connected to the second rotor;
wherein one of the first and second rotatable components is part of a reusable assembly; and
wherein the other of the first and second rotatable components is part of a disposable assembly.

56. A magnetic coupling comprising:
a first rotor comprising a plurality of permanent magnets spaced apart by ferromagnetic teeth, the plurality of permanent magnets disposed about a rotational axis; and
a second rotor comprising a plurality of pole pairs disposed about the rotational axis, the first and second rotors magnetically coupled together such that the first rotor and the second rotor rotate about the rotational axis together at substantially the same rotational speed during operation of the magnetic couplings.

57. The magnetic coupling of claim 56, wherein the first rotor comprises an inner rotor and the second rotor comprises an outer rotor, the inner rotor disposed radially within the outer rotor.

58. The magnetic coupling of claim 56, wherein the first rotor comprises a proximal rotor and the second rotor comprises a distal rotor, the first and second rotors disposed adjacent one another along the rotational axis.

59. The magnetic coupling of claim 56, wherein the first rotor comprises a conical outer surface with the plurality of permanent magnets disposed at or near the outer surface, wherein the second rotor comprises a conical inner surface with the plurality of pole pairs disposed at or near the inner surface, the outer and inner surfaces spaced apart by an air gap.

60. The magnetic coupling of claim 56, wherein at least one pole pair of the plurality of pole pairs includes a first polarity region and a second polarity region having a different polarity from the first polarity region, the first and second polarity regions being formed of different materials.
